(19) United States
(12) Patent Application Publication
(10) Pub. No.: US 2004/0215537 A1
(43) Pub. Date: Oct. 28, 2004

(54) Banking process and application architecture

(76) Inventor: Martin Walter Schroter, Bad Schoenborn (DE)

Correspondence Address: KENYON & KENYON, 1500 K STREET, N.W., SUITE 700, WASHINGTON, DC, 20005, US

(21) Appl. No.: 10/422,797

(22) Filed: Apr. 25, 2003

(51) Int. Cl. G06F 17/60

(52) U.S. Cl. 705/35

(57) ABSTRACT

The present invention relates to increasing efficiency in banking-related software. According to the invention, banking application software is organized into classes according to a type of functionality exhibited by the software. The functionality is generic to avoid redundancy and reduce complexity.

### FIELD OF THE INVENTION

The present invention relates generally to software, and more specifically to a method and system for organizing and executing application software in the banking industry.

### BACKGROUND INFORMATION

Banking-related activities are nowadays largely implemented or supported by software applications. “Banking-related activities” as used herein means acts, operations, functions, processes, services or the like, performed in connection with or in support of or as a consequence of banking-related matters. The way banking-related activities are currently performed is hampered by inefficiencies having to do with how the associated software is organized and structured.

FIG. 1 shows one arrangement of banking software applications as they are currently implemented. Banking applications are typically structured to support banking-related activities that may be viewed, according to many within the industry, as being distributed among four general types: “front office” activities 100, “trading office” activities” 101, “middle office” or “settlement” activities 102, and “back office” activities 103. It should, of course, be understood that the terms “front office,” “middle office”, “back office” and “trading office” do not refer to specific locations or buildings, but to banking-related activities that are commonly associated with a particular type, or phase or stage, of banking business.

Inefficiencies in known banking software applications include that the applications typically too narrowly tailored. The data stream between the applications are point-to-point interfaces with tailored messages and semantics. Changes of processes and implementations of new products are very difficult. More specifically, the applications are typically product-dependent, channel-dependent or limited to applicability within a given organizational structure (front, middle or back office as outlined above). A “product” as used herein means, for example, a particular kind of bank service, such as deposits, loans, cash accounts, cards and the like. A “channel” refers to a medium via which a customer accesses bank services; examples (see FIG. 1) include branch offices 104, the Internet 105, ATMs 106, call centers 107, mobile telecommunication devices 108, and the like.

The product and channel dependencies of the banking applications leads, among other things, to redundancy, inconsistent results, lack of communication across channels, and difficulty in developing and supporting applications for new products. Referring to FIG. 1, it can be seen, for example, that each channel 104-108 has its own version of associated application software 109-113. Thus, there are three versions of “contact center and activity management” applications 109, 110 and 112, and two versions of “authorization and access” applications 111 and 113. Though having common functionality, each of applications 109-113 is individually tailored to a particular channel, and therefore the common functionality is duplicated and cross-channel communication is not available.

The product dependency of applications is also illustrated in FIG. 1. For example, product offering process application 120 is tailored to loans, product offering process application 121 is tailored to cash accounts, product offering process application 122 is tailored to savings, and product offering process application 123 is tailored to loans. Each of these product offering process applications has similar or common functionality, and so it can be observed that considerable redundancy exists across applications 120-123. Similarly, transaction process application 124 is tailored to checks, and transaction process application 125 is tailored to cards, and implement redundant functionality.

Along similar lines, analytical processes in different departments or offices that should yield the same results, may not. For example, risk calculations in loan appraisals (a middle office activity—see block 114 in FIG. 1) are very important because risk profiles of customers influence the interest rates. Risk calculations are also performed as a back office activity (see block 115), for example to calculate risk profiles for customers aggregated for regulatory reporting. However, each of the middle office and back office has its own version of the risk calculation (114, 115), leading, again, to some redundant functionality, and to possible inconsistency of results between the two offices.

Duplication and application dependency of data is also illustrated in FIG. 1. For example, each of back office applications 130-134 has its own financial database.

Given new trends in the banking industry, the inefficiencies described above are notably disadvantageous. These trends include:

Consolidation: Size remains an important factor in the banking industry. Scale effects are an important success factor, especially in production/processing facilities.

Breaking up of the banking “value chain”: De-coupling of production/processing facilities from distribution units is expected to increase in the banking industry. The emergence of specialist companies will increase due to enhanced outsourcing efforts.

A changing regulatory environment: Pan-European harmonization is becoming the major trend in the banking industry. Changes in the regulatory environment determine the speed at which business models and processes in the banking industry must adjust.

Customer-focused services: There is a shift from product-oriented offerings to demand-oriented offerings including intensification of customized products and services. Such customization includes configuration of customer-tailored products at the point of sales, communication or information across channels, and product lines focused on customer needs.

In view of the foregoing considerations, a new approach is needed.

### SUMMARY OF THE INVENTION

To provide greater flexibility and efficiency and reduce complexity as compared to the prior art, the present invention uses a product-independent, channel-independent and organizational-structure-independent service application architecture approach to banking, rather than a product-dependent, channel-dependent, organizational-structure—dependent approach as in the prior art. In a method and system according to embodiments of the invention, a uniform and consistent developmental and operational architectural model is defined for banking-related application software, and the software is developed and implemented in accordance with the model. According to embodiments, the model includes three classes or categories of functional orientation with respect to banking-related activities, and software applications are designed to implement generic functionality of the respective classes. A common interface may be provided to enable communication between the generic functionality of each class.

### BRIEF DESCRIPTION OF THE DRAWINGS

FIG. 1 illustrates an arrangement of banking-related software according to the prior art;

FIG. 2A shows three broad categories of banking-related software functionality according to embodiments of the present invention;

FIGS. 2B and 2C compare an example of processes as implemented in the prior art, and an example of processes as implemented according to the invention;

FIG. 3 illustrates components of a customer-oriented class of applications;

FIG. 4 illustrates components of a transaction-oriented class of applications;

FIG. 5 illustrates components of an analytical-oriented class of applications;

FIG. 6 shows a central services group of applications which may be used by each of classes of applications according to the invention;

FIG. 7 shows various components of the present invention in use;

FIG. 8 shows a detailed breakdown of components of the invention;

FIG. 9 illustrates an exchange of functionality between application groups according to the present invention; and

FIG. 10 shows a computer system for implementing the invention.

### DETAILED DESCRIPTION

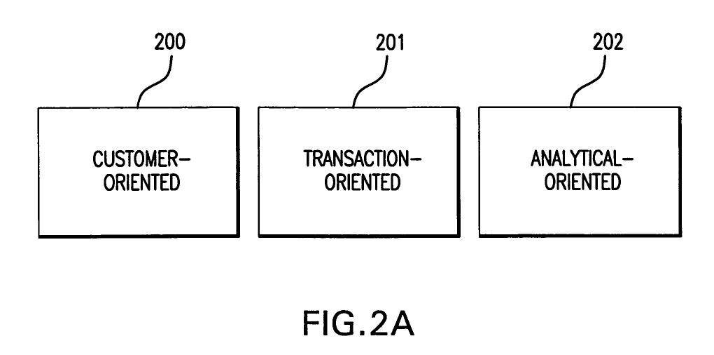

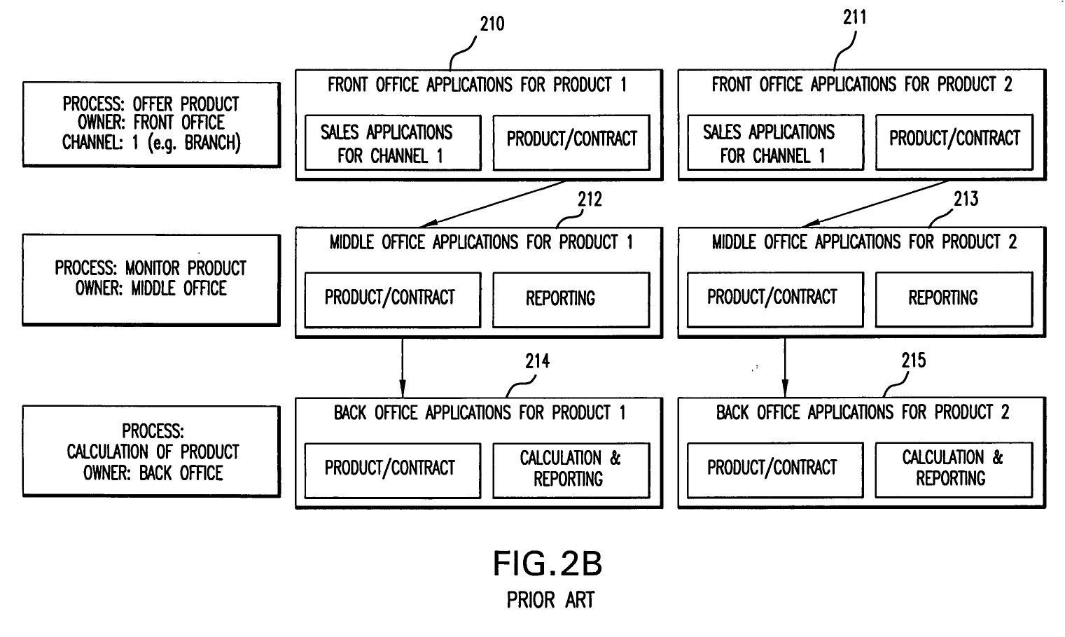

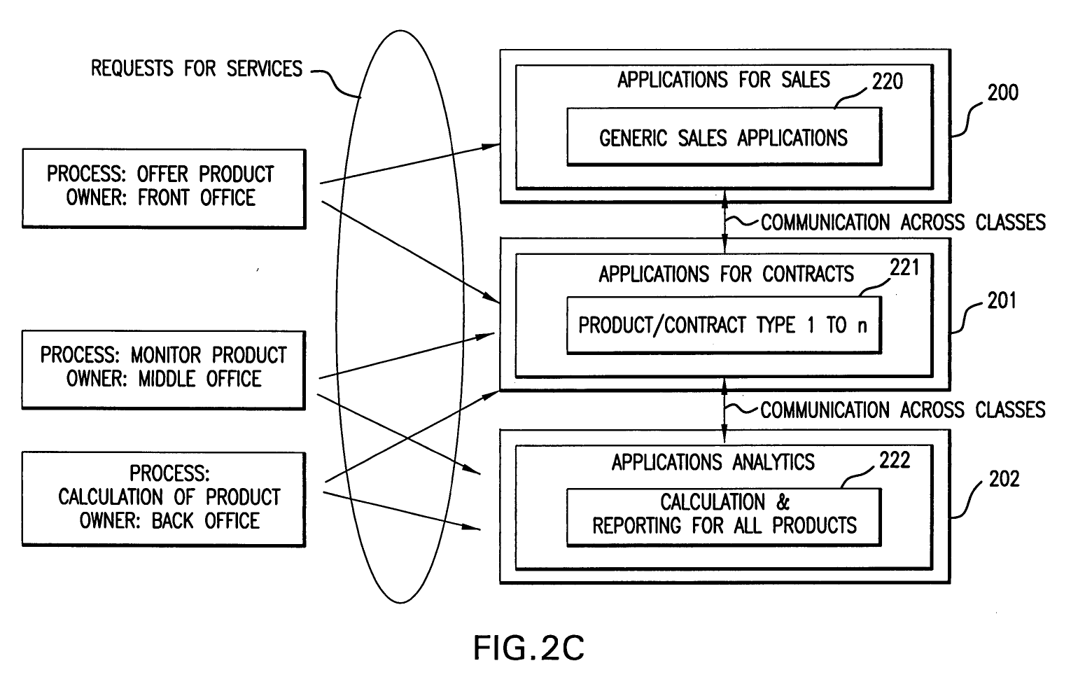

FIG. 2A illustrates three of possible classes or categories of banking-related functionality according to embodiments of the invention: a customer-oriented class 200, a transaction-oriented class 201, and an analytical-oriented class 202. When it is said here that a given functionality has a particular “orientation,” it means that the functionality has a primary use or applicability within a defined sphere of banking activities. For example, the customer-oriented class contains all functionality which manages communication and contact with, and services to, customers. The transaction-oriented class contains all functionality for managing transactional data, e.g., data relating to contracts and accounts. The analytical-oriented class contains all functionality for analyzing and reporting on banking business. “Functionality” means a function or a plurality of functions. The functionality of each category may be implemented in a banking-related application or applications. “Banking-related application” here means functionality implemented in computer-executable instructions to meet a requirement associated with a banking-related activity. An application may be a program module.

Customer-oriented applications may be characterized in that they use customer parameters as drivers. A “driver” is a unit or quantum of input data that the logic of a given class of functionality is designed to act upon to produce a consistent or relevant output. Transaction-oriented applications may be characterized in that they use contract or transaction parameters as drivers. Analytical-oriented applications may be characterized in that they use business performance measurement and calculation parameters as drivers.

For example, a customer-oriented application could be used to produce an account statement by providing, to the customer-oriented application, drivers including such customer parameters as a preferred channel, the accounts which should be reported together, personalized messages, account fees, and the like, for a particular customer.

Other examples of processes that could be performed by customer-oriented applications include generating financial advice, origination of new contracts and accounts, capturing investment orders, customer-oriented configuration of offerings and products, customer-oriented rating and scoring, customer-specific pricing, customer-specific printouts of account statements, customer-specific overviews of the banking relationship, business (contract, services, etc.) and contacts, services for complaints, services for payments and monitoring of accounts, and providing information to customers about conditions, fees, products and services.

For a transaction-oriented application, drivers could include such parameters as posting data (e.g., date and amount), and contract-related parameters such as maturity dates. For example, functionality of the transaction-oriented class could be used to calculate interest and fees for the customer accounts mentioned above.

Other examples of processes that could be performed by transaction-oriented applications include defining products to execute across product lines, administering customer contracts and accounts, authorizing and processing transactions and payments, monitoring payments, accounts and contracts, initiating processes like rollover, processing legal actions, aligning cash flows of different products, processing corporate actions, calculating fees, provisions and interest, and determining customer beneficiaries.

As noted above, the analytical-oriented class contains all functionality for analyzing and reporting on banking business, and may perform, for example, calculations for reporting according to defined business evaluation criteria such as risk, profitability (e.g. for contracts) and accounting valuations for the balance sheet. The analytical-oriented class may further include functions like rating or scoring of customers, and aggregation and grouping to address the different information needs of various entities, such as profit centers, a single customer, a region, and so on.

Other examples of processes that could be performed by analytical-oriented processes include segmentation of customers and groups of customers, accounting and consolidation, risk simulations, regulatory reporting, measuring KPI (key performance indicators), analyzing sales activities, simulation into the future, and historical analytics and trend calculations.

FIGS. 2B and 2C illustrate how the structure of the invention may be used to make banking processes more efficient as compared to prior art approaches. FIG. 2B shows a prior art approach. FIG. 2B exemplifies a “point-to-point” structure where data flow and functionality are tailored to a particular product, channel, and organizational structure (front, middle, back office). In FIG. 2B, processes and associated applications for two different products, Product 1 and Product 2, are shown. Both Product 1 and Product 2 use an “Offer Product” process designed for a specific process owner, i.e., the front office, and a specific channel, e.g., a branch office. There is a group of associated front office applications 210 for Product 1, and a group of associated front office applications 211 for Product 2. It can be seen that each of the groups 210 and 211 of front office applications uses common functionality, “Sales Applications for Channel 1” and “Product/Contract”, but that these are replicated across the groups 210 and 211.

Similarly, both Product 1 and Product 2 use a “Monitor Product” process designed for the middle office. There is a group of associated middle office applications 212 for Product 1, and a group of associated middle office applications 213 for Product 2. Each of the groups 212 and 213 of middle office applications uses common functionality, “Sales Applications for Channel 1” and “Product/Contract”, but these are replicated across the groups 212 and 213. Moreover, the “Product/Contract” functionality is also duplicated across the front office and middle offices.

Finally, both Product 1 and Product 2 use a “Calculation of Product” process designed for the back office. There is a group of associated back office applications 214 for Product 1, and a group of associated back office applications 215 for Product 2. Again, there is redundancy of functionality across groups 214 and 215, and across the middle and back offices.

FIG. 2C shows an approach according to the present invention, by contrast. In FIG. 2C, generic functionality of each class is used to implement processes. Services performed by the functionality are available to all processes, regardless of the organizational structure performing the process. Thus, for example, the “Offer Product” process of the front office is able to request services from generic sales applications 220 in the customer-oriented class of applications 200, and request services from the generic product/contract applications 221 in the transaction-oriented class of applications 201. Similarly, for example, the “Monitor Product” process is able to request services from the generic product/contract applications 221, and services from the generic calculation and reporting applications 222 in the analytical-oriented class of applications 202. And, the “Calculation of Product” process is able to requests services from the generic product/contract applications 221, and from the generic calculation and reporting applications 222. Access to functionality through the services is therefore independent of the product, channel or organizational structure. Communication between applications of different classes may also be enabled, as discussed in more detail below.

It may be appreciated that the structure of FIG. 2C offers significant improvement over the structure of FIG. 2B. Because generic functionality is localized in one place and commonly available, the redundancy, product dependency, channel dependency and organizational structure dependency of the prior art is avoided. It may further be appreciated how the structure of FIG. 2C eases software development, since changes to common functionality need only be made in one place.

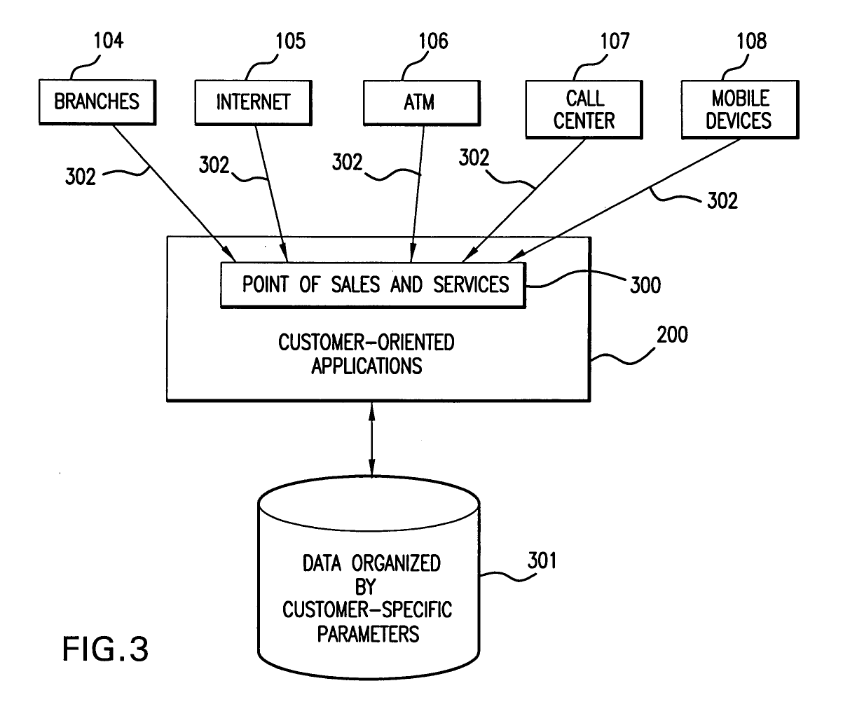

Banking-related applications within the customer-oriented category, as noted earlier, include functionality configured to control, document and store all business contacts between customers and a bank. Moreover, the functionality of the customer-oriented applications may be channel independent. This is illustrated in FIG. 3. FIG. 3 shows external requesting entities, e.g., bank customers, issuing requests for service 302 to the customer-oriented group of applications 200 via channels 104-108. The requests 302 are handled by a single, channel-independent “point of sales and services” application 300 which acts as a uniform, generic interface for all the channels. The application 300 may simply be a technical layer with no business-related functionality, designed to handle the differences in communication formats of the various channels, and pass along a request to the business-oriented applications of the customer-oriented group. While the point of sales and services application 300 and other customer-oriented applications have generic functionality, the customer-oriented applications may store information in, and retrieve information from, a database 301 organized by customer-specific parameters, for example, a customer number.

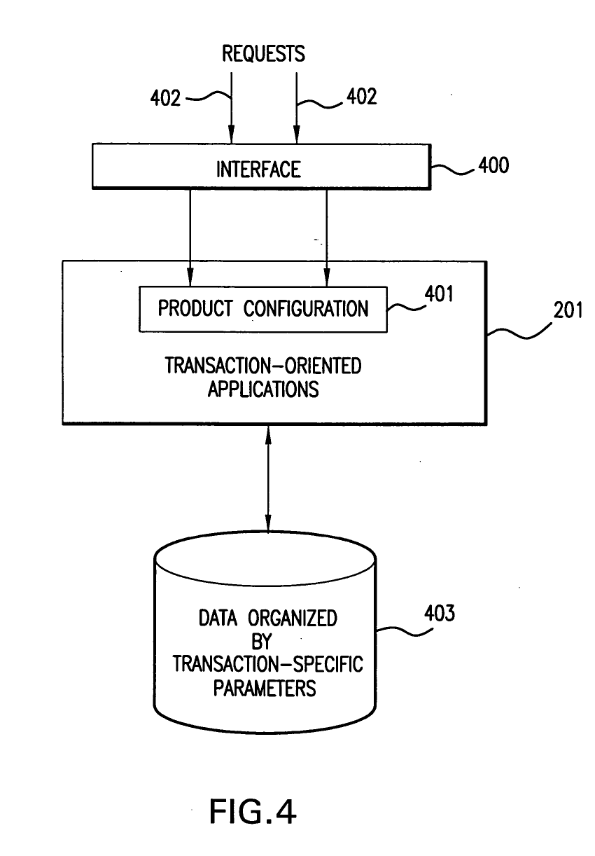

Referring to FIG. 4, banking-related applications within the transaction-oriented category 201, include, as noted above, functionality configured for the processing of contracts, such as functionality for position tracking of securities (e.g., recording value fluctuations of a stock position per day based on the buying and selling record) and loans (e.g., out-payments, interest payments and redemptions for mortgage loans), contract maintenance and monitoring. The functionality is generic and includes, for example, calculation methods (financial mathematics) and plausibility checks. According to embodiments, the transaction-oriented category may include only a single occurrence of each kind of required functionality: i.e., member applications have functionality which is not replicated across classes, in order to avoid redundancy.

Users, for example, employees performing middle-office activities, may use the generic functionality of the transaction-oriented applications 201 to implement specific requirements by, for example, supplying specific information to the transaction-oriented applications via a standardized user interface 400. The user interface 400 could comprise, for example, a set of general parameters that would be provided with particular values by requests for functionality 402. Examples of particular values include GUIDs (globally unique identifiers) for contracts, client identifiers, and the like. A particular set of parameters may be supplied to a product configurator 401 to describe a particular contract or product. The transaction-oriented applications may store information in, and retrieve information from, a database 403 organized by transaction-specific parameters, for example, contract numbers.

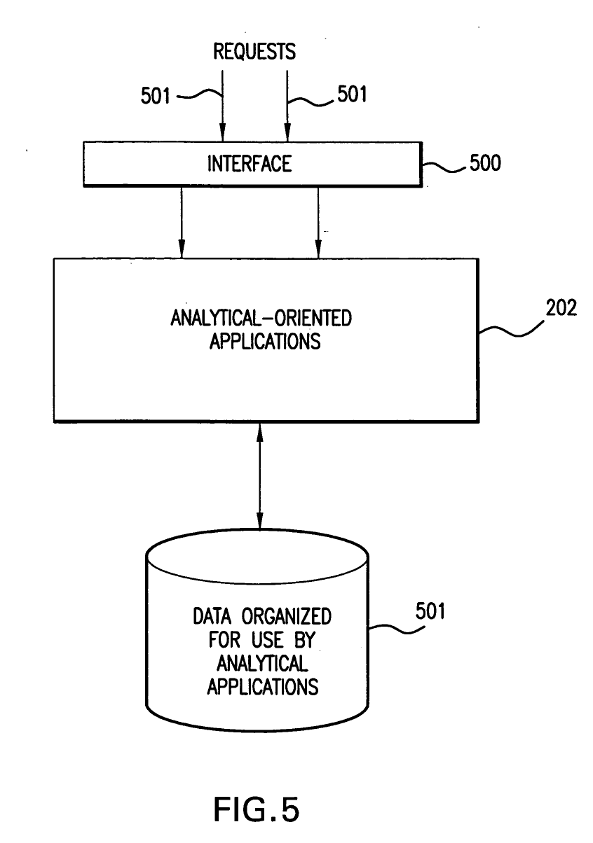

Illustrated in FIG. 5, banking-related applications within the analytical-oriented category 202, include, for example, functionality configured for the analysis of and reporting on contract and customer data. The analytical functionality is generic and de-coupled from the transaction-oriented and customer-oriented applications. Each application may occur only a single time across all classes, to avoid redundancy. The analytical applications may be configured to give results at a desired “granularity”: i.e., at anywhere from a business unit level, regional level or top of the company view down to an individual customer level.

Users, for example, employees performing back-office activities, may use the generic functionality of the analytical-oriented applications 202 to meet specific requirements by, for example, supplying specific information to the analytical-oriented applications via a standardized user interface 500. The analytical-oriented applications may store information in, and retrieve information from, a database 501 organized for use by analytical applications.

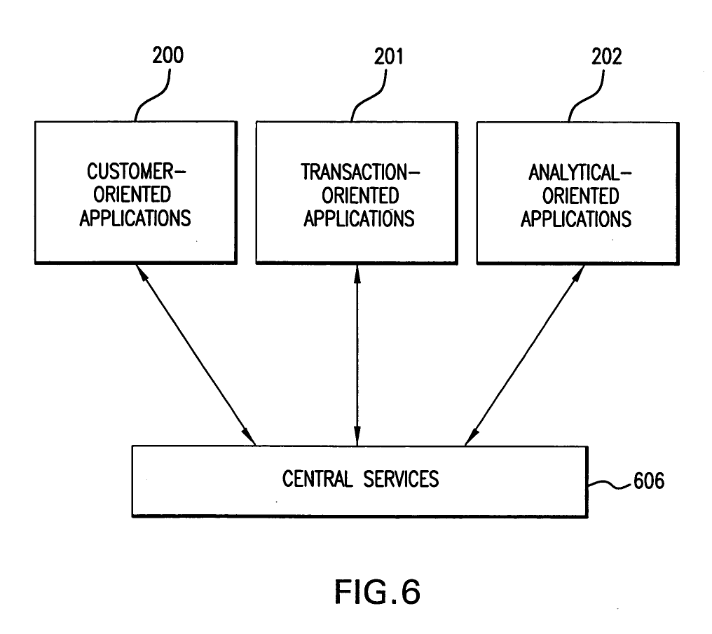

As shown in FIG. 6, each of the group of customer-oriented applications 200, transaction-oriented applications 201, and analytical-oriented applications 202 may access central services 600. Central services 600 comprises a group of applications having general functionality needed by all of the application groups. The central service applications include applications to communicate with market price providers, authorize employee access, archive information, perform printing and the like.

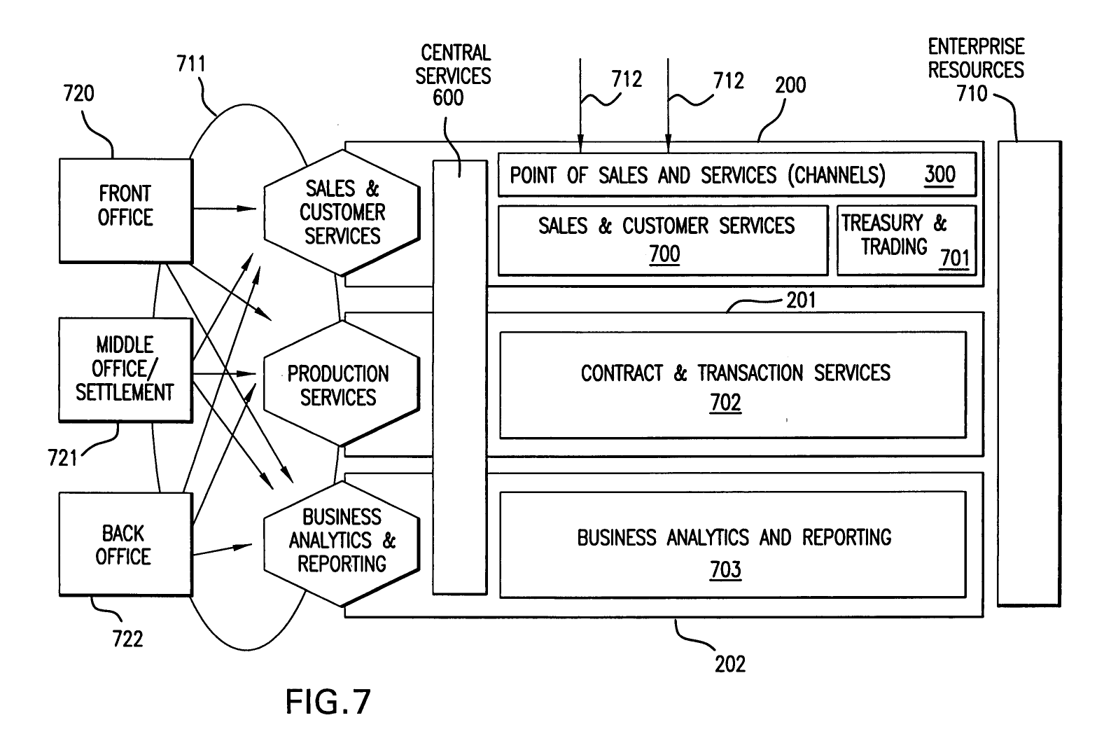

FIG. 7 is a high-level view illustrating various components of the present invention in use. Each of front office activities 720, middle office/settlement activities 721, and back office activities 722, performed by, for example, bank employees, may involve issuing requests for functionality 711 to any one of the group of customer-oriented applications 200, the group of transaction-oriented applications 202, or the group of analytical-oriented applications, in order to meet a requirement of a banking-related activity. Moreover, external requests for functionality 712, issued, for example, by bank customers via channels, may be received by channel-independent interface (point of sales and services) 300. In response, the functionality of a given application may be executed to satisfy the request or meet the banking-related requirement.

A more detailed breakdown of applications is also shown in FIG. 7. For example, the class of customer-oriented applications may include the subclasses of sales and services applications 700 and treasury and trading applications 701. The class of transaction-oriented applications may include the subclass of contract and transaction services applications 702. The class of analytical-oriented applications may include the subclass of business analytics and reporting applications 703. Enterprise resources 710 are the typical applications which every enterprise in all industries need, like applications directed to inventory, human resources, and information-gathering.

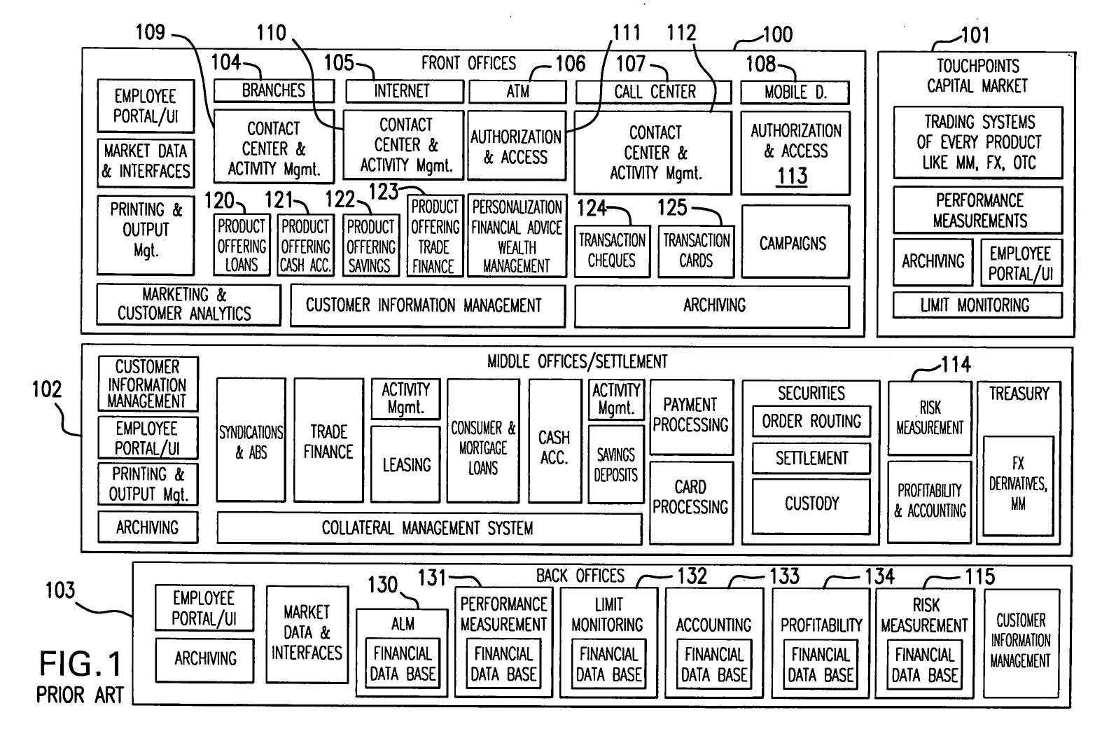

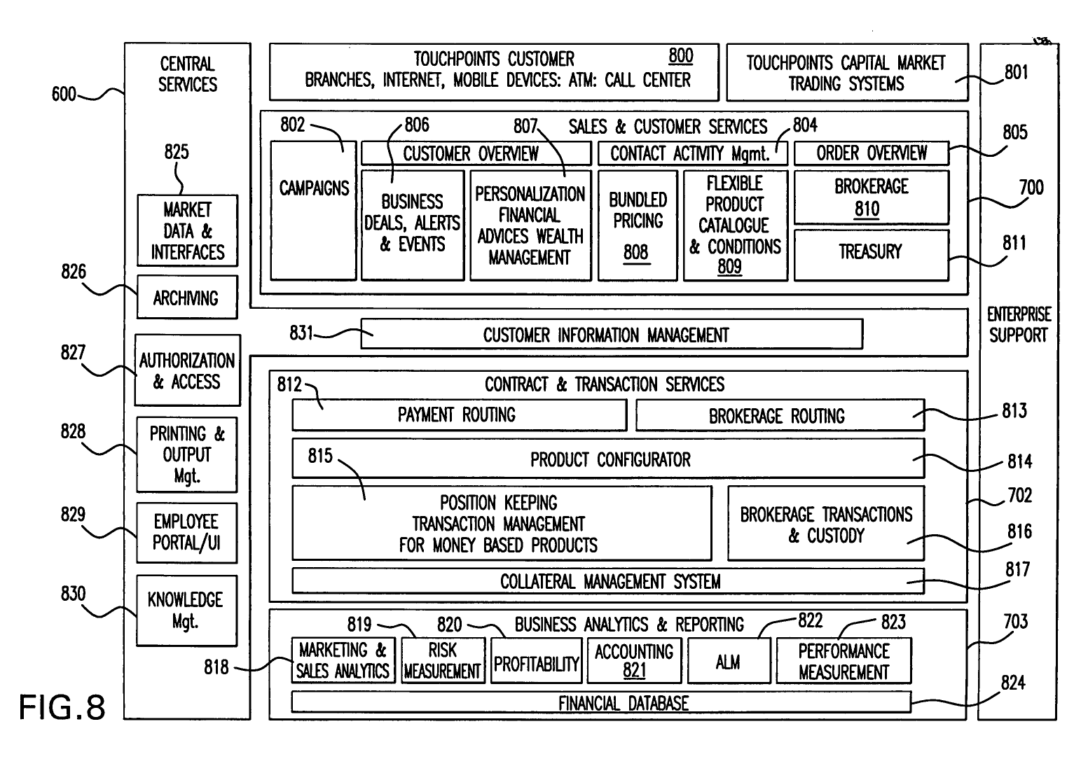

FIG. 8 shows a still more detailed breakdown of applications. As shown in FIG. 8, the point of sales and services subclass may include a “touchpoints customer” (point of customer contact) subclass 800. The treasury and trading subclass may include a “touchpoints” (point of contact of) capital markets and trading system 801. The subclass of sales and services applications 700 may include the subclasses of campaigns 802, customer overview 803, contact and activity management 804, order overview 805, business deals, alerts and events 806, personalization, financial advice and wealth management 807, flexible product catalogue and conditions 809, brokerage 810 and treasury 811. The subclass of contract and transaction services 702 may include the subclasses payment routing, 812 brokerage routing 813, product configurator 814, position keeping and transaction management for money based products 815, brokerage transactions and custody 816, and collateral management system 817 The subclass of business analytics and reporting 703 may include the subclasses of marketing and sales analytics 818, risk measurement 819, profitability 820, accounting 821, ALM 822, performance measurement 823, and financial database 824. Central services 600 may include market and data interfaces 825, archiving 826, authorization and access 827, printing and output management 828, employee portal/UI 829, knowledge management 830 and customer information management 831. It may be appreciated that, as compared with FIG. 1, there is no duplication of applications or redundancy of functionality in FIG. 8.

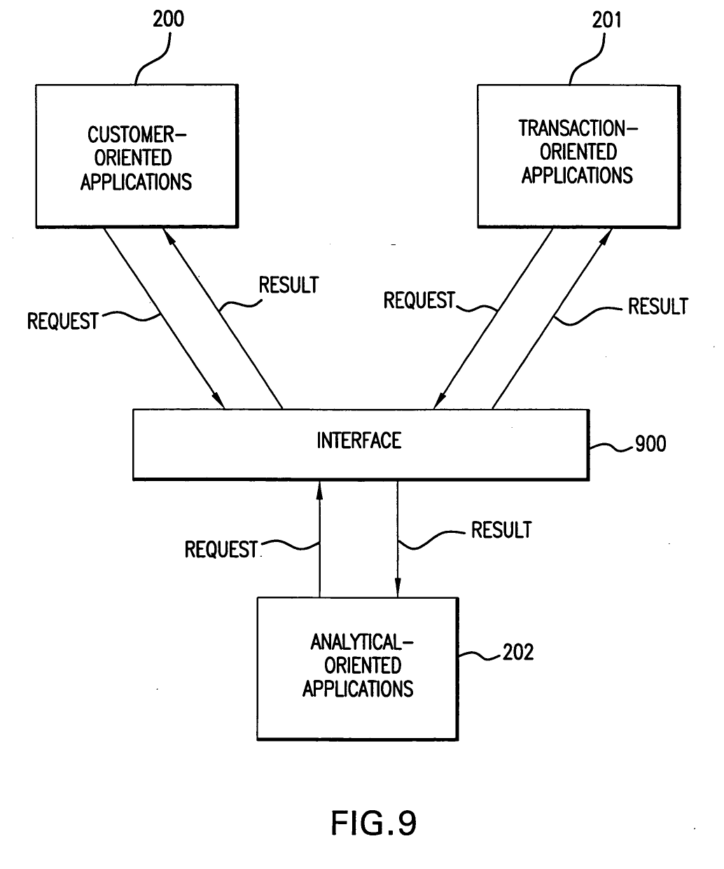

The applications of each group may be configured so as to be able to exchange information and share functionality. This is illustrated in FIG. 9. According to embodiments of the invention, a common internal interface 900 may be provided to enable the applications to exchange functionality and data according to a uniform methodology. Such a uniform methodology could be implemented, for example, in the form of a published API (application programmer's interface). Communication between the classes could be necessary in order to satisfy interdependencies between, or requirements of, banking-related activities which are being implemented at least in part by the applications of the various classes. More specifically, for example, applications within the customer-oriented group 200 or analytical-oriented group 202 requiring functionality or data from applications within the transaction-oriented class 201 might request the functionality or data from the transaction-oriented class 201 via the interface 200. The applications within the transaction-oriented class 302 could then perform the requested functionality or retrieve the requested data and return a result via the interface. Or, for example, applications within the transaction-oriented group 201 could request functionality or data from applications within the customer-oriented group 200 or analytical-oriented group and receive a result via the interface, and so on. It may be observed that the structure illustrated in FIG. 9 greatly simplifies development tasks, because changes to applications of one group does not require changes to applications of another group, but only, potentially, to their common interface.

In view of the foregoing, benefits of the present invention to the banking business include that it provides a consistent model for future software development, enables flexible adaptation to future growth and business changes, and reduces system complexity and redundancy. Moreover, it may be observed that in addition to being product-independent and channel-independent as described above, the system and method according the invention are also business-independent. That is, for example, businesses commonly associated with the banking business, such as insurance or securities trading, could readily use the services of the described architecture.

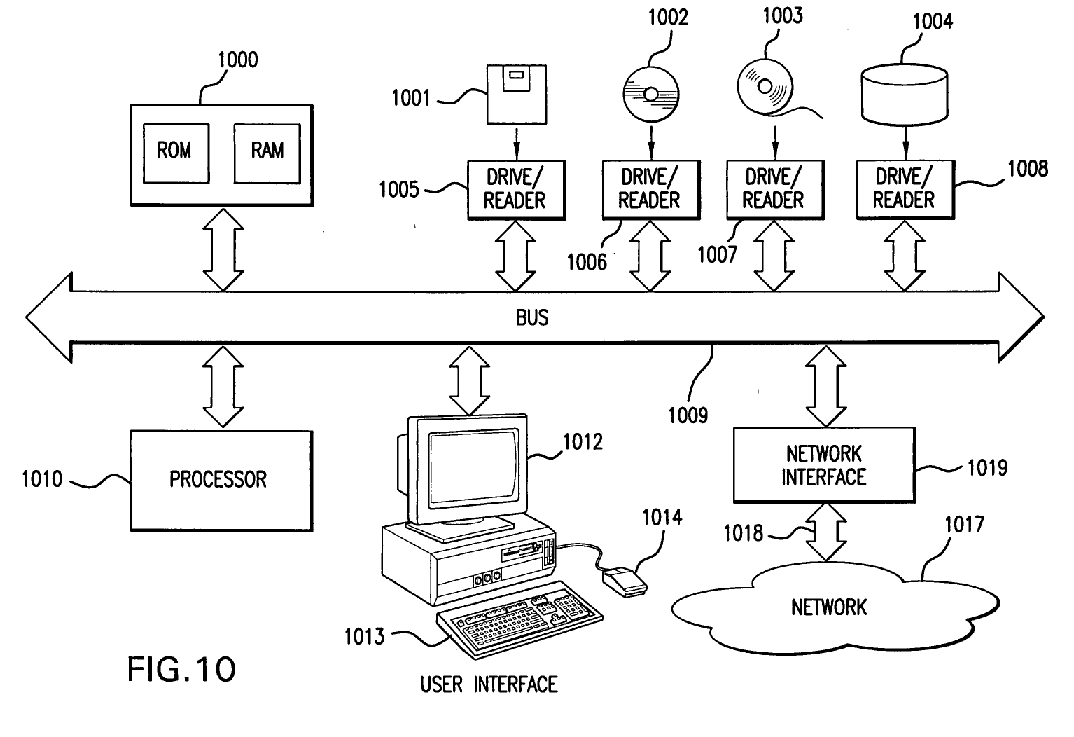

FIG. 10 shows a high-level representation of a computer system for implementing a preferred embodiment of the present invention, such as might be realized by a variety of known and commercially available hardware and software elements as embodied in, for example, a workstation, a mainframe computer, a personal computer, or other hardware platform. The system comprises a memory 1000 including ROM and RAM, processor 1010 and user interface 1011 comprising a video display 1012, keyboard 1013 and mouse 1014. Elements may communicate via system bus 1009. The system may further comprise a network 1017 connected by a network medium 1018 and network interface 1019.

A computer program or collection of programs comprising computer-executable instructions for performing method steps according to the present invention may be stored and transported on computer-usable media such as diskette 1001, CD-ROM 1002, magnetic tape 1003 and fixed disk 1004. To perform the steps of the method, computer instructions according to the present invention may be retrieved from the computer-usable media 1001-1004 using their respective drive/readers 1005-1008 into memory 1000, and executed by a processor 1010. The process steps and functionality disclosed hereinabove for performing the method may find specific implementations in a variety of forms, which are considered to be within the abilities of a programmer of ordinary skill in the art after having reviewed the specification.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of performing banking-related activities, comprising:
executing banking-related software, the banking-related software being based on an architectural model including at least the classes of customer-oriented functionality, transaction-oriented functionality, and analytical-oriented functionality, wherein executing the banking-related software includes:
providing generic functionality corresponding to a functional orientation of each class;
providing an interface to enable communication between the generic functionality of each class;
receiving a request for functionality from a requesting entity; and
performing a generic functionality to satisfy the request.

2. The method of claim 1, wherein the request corresponds to any one of front office, middle office or bank office activities.

3. The method of claim 1, wherein the interface is an API.

4. The method of claim 1, wherein the class of customer-oriented functionality is configured to process a service request independently of a channel via which the request is received.

5. A system for efficiently performing banking-related activities, comprising:
a storage medium storing a plurality of customer-oriented applications, a plurality of transaction-oriented applications, and a plurality of analytical-oriented applications, each of the customer-oriented applications, transaction-oriented applications and analytical-oriented applications being configured to implement generic banking-related functionality of the corresponding orientation and communicate with each other through a common interface; and
a processor configured to execute the applications.

6. The system of claim 5, further comprising a database organized by customer-specific parameters for use by the customer-oriented applications.

7. The system of claim 5, further comprising a database organized by transaction-specific parameters for use by the transaction-oriented applications.

8. The system of claim 5, further comprising a database organized for use by the analytical-oriented applications.

9. A method of developing banking-related software, comprising:
defining an architectural model including at least two classes of banking-related functionality; and
developing generic applications having functionality corresponding to the at least two classes, where the generic applications are configured to communicate with each other through a common interface.

10. The method of claim 9, wherein the at least two classes relate to customer-oriented functionality and transaction-oriented functionality, respectively.

11. The method of claim 9, wherein the at least two classes further include a class relating to analytical-oriented functionality.

12. The method of claim 9, wherein the functionality is configured to execute in response to a customer request for service.

13. The method of claim 9, wherein the functionality is configured to execute in response to a bank-internal request for service.

14. A machine-readable medium tangibly embodying computer-executable instructions, the instructions comprising banking-related software organized according to an architectural model defined in terms of a functional orientation of the software with respect to banking-related activities, the model including at least the classes of customer-oriented functionality, transaction-oriented functionality, and analytical-oriented functionality, the instructions further being configured to:
provide generic functionality corresponding to a functional orientation of each class;
provide an interface to enable communication between the generic functionality of each class;
receive a request for functionality from a requesting entity; and
perform a generic functionality to satisfy the request.

15. The medium of claim 14, wherein the class of customer-oriented functionality is configured to process a service request independently of a channel via which the request is received.
